(19) United States
(12) Patent Application Publication
(10) Pub. No.: US 2010/0198642 A1
(43) Pub. Date: Aug. 5, 2010

(54) METHOD AND SYSTEM FOR MANAGING ONE OR MORE PROCESSES IN AN ORGANIZATION

(76) Inventors: Gautam Nadkarni, Mumbai (IN); I. B. Madhukar, Hyderabad (IN); Himani Tewari, Haldwani (IN); Elton Martin Barretto, Mumbai (IN); Praveen Poornima Muraleedharan Nair, Trivandrum (IN); Rahul Sinha, Ambikapur (IN); S. Subramania Satish Kumar, Coimbatore (IN); Rohit Nand, Bangaore (IN); Vishwanathan S., Salem (IN)

Correspondence Address: MICHAEL BEST & FRIEDRICH LLP, 100 E WISCONSIN AVENUE, Suite 3300, MILWAUKEE, WI, 53202, US

(21) Appl. No.: 12/614,766

(22) Filed: Nov. 9, 2009

(30) Foreign Application Priority Data
Nov. 10, 2008 (IN) 2751/CHE/2008

(51) Int. Cl. G06Q 10/00

(52) U.S. Cl. 705/8; 705/7

(57) ABSTRACT

The present invention provides a method, system and computer program product for managing one or more processes in an organization. The system enables a user to define various process clusters. The process clusters include various associated processes that are made compliant with a predefined set of standards. Further, the system integrates various process clusters and enables interaction among various processes. Furthermore, the system provides a common access to the process clusters and the associated processes.

### BACKGROUND

The present invention relates to managing processes in an organization using a single framework.

The Information Technology (IT) department of a business organization uses a varied set of processes for the internal groups and functions of the organization. Each of these processes complies with its corresponding standard. Examples of the processes that comply with the standards include application development processes using Capability Maturity Model Integration (CMMI) as a process model, information security processes using the International Organization for Standardization (ISO) 27001 standard, Information Technology Infrastructure Library (ITIL) based processes, and so forth. Typically, the different processes employed by different groups are accessed individually for use in the organization. Therefore, the use and management of the varied set of processes is a tedious and time-consuming job for the IT department of the organization.

Conventionally, the different processes are categorized under various process frameworks, hereinafter referred to as frameworks. However, the processes are neither clearly defined nor clearly categorized under different frameworks. Further, there is no common access for the groups and functions of the organization to the frameworks. In addition, there is a lack of clarity regarding whether the framework used by one group will complement or contradict with the framework used by another group in the organization. Moreover, some processes in the frameworks may not comply with the industry standards.

In light of the above, there is a need for a method, system and computer program product for efficiently managing the processes in the organization.

### SUMMARY

An object of the invention is to manage multiple processes in an organization using a single framework.

Another object of the invention is to ensure compliance of the processes with a set of standards.

To achieve the objectives mentioned above, the present invention provides a method, system and computer program product for managing multiple processes in an organization. An organization uses multiple processes for its different groups and functions. In accordance with the embodiments provided in the present invention, multiple processes are classified into various process clusters in order to ease understanding and usage. Each process cluster includes one or more processes and process workflows describing the corresponding processes. Further, compliance of each process in the process cluster is established with a corresponding standard selected from a predefined set of standards. Thereafter, the multiple process clusters are integrated in at least one framework. The integration of the process clusters enables a concurrent implementation of the process clusters and interaction between different processes in the process clusters. Thenceforth, a common access to the process clusters is provided through the integrated framework.

The method, system and computer program product described above have various advantages. The method enables concurrent management of various processes using a single framework. Further, each process is compliant with the corresponding standard. Furthermore, the present invention enables interaction among various processes, including those belonging to different process clusters. The method and system also enables the users to access these processes through a user-friendly interface, thereby facilitating accessibility throughout the organization. The system also provides various process workflows and process descriptions, thereby enabling common understanding of the processes. Moreover, the framework can be customized based on the requirements of the organization, thus ensuring applicability across various organizations.

### BRIEF DESCRIPTION OF THE DRAWINGS

The various embodiments of the invention will hereinafter be described in conjunction with the appended drawings, provided to illustrate and not to limit the invention, wherein like designations denote like elements, and in which:

FIG. 1 illustrates an environment in which various embodiments of the invention may be practiced;

FIG. 2 is a flowchart of a method for managing processes in an organization, in accordance with an embodiment of the invention;

FIGS. 3a, 3b, 3c and 3d diagrammatically represent interactions of a process cluster with various other process clusters, in accordance with an exemplary embodiment of the invention;

FIG. 4 is a block diagram of a system for managing processes in the organization, in accordance with an embodiment of the invention;

FIG. 5 is a snapshot depicting a process workflow in the organization, in accordance with an exemplary embodiment of the invention;

FIG. 6 is a snapshot depicting a sub-process swim lane for a particular activity/sub-process associated with a process, in accordance with an exemplary embodiment of the invention;

FIG. 7 is a snapshot depicting an organization structure of the organization, in accordance with an exemplary embodiment of the invention;

FIG. 8 is a snapshot depicting a process description associated with a process, in accordance with an exemplary embodiment of the invention;

FIG. 9 is snapshot depicting a Responsible Accountable Consulted and Informed (RACI) chart associated with a process, in accordance with an exemplary embodiment of the invention;

FIG. 10 is snapshot depicting a template, in accordance with an exemplary embodiment of the invention;

FIG. 11 is a snapshot depicting a form, in accordance with an exemplary embodiment of the invention; and

FIG. 12 is snapshot depicting a checklist for a process, in accordance with an exemplary embodiment of the invention.

### DESCRIPTION OF VARIOUS EMBODIMENTS

The invention describes a method, system and computer program product for managing one or more processes in an organization. Various processes are categorized into one or more process clusters. Further, a framework is provided to facilitate common access to various process clusters and the associated processes, thereby enabling concurrent management of various processes.

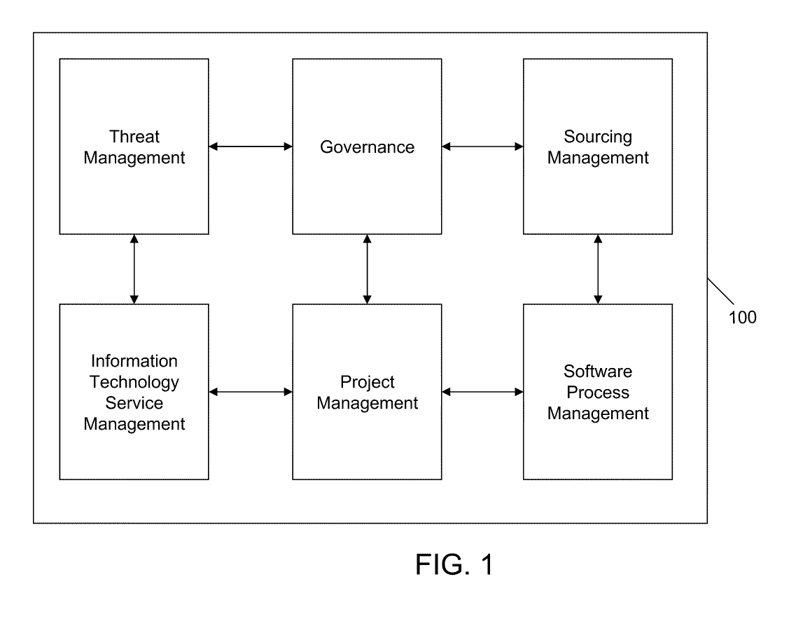

FIG. 1 illustrates an environment 100 in which various embodiments of the invention may be practiced. Environment 100 includes various process clusters employed in an organization.

In an organization, various processes are employed in various departments and at various stages. Typically, such processes are accessed and managed by the Information Technology (IT) department of the organization. The processes are categorized into various process clusters on the basis of their IT domains. For example, ‘Threat Management’, ‘Governance’, ‘Sourcing Management’, ‘Information Technology (IT) Service Management’, ‘Project Management’, and ‘Software Process Management’ are the typical process clusters that are used in one or more organizations. A process cluster is a conglomeration of various processes sharing common characteristics and purposes. For example, the ‘Governance and Security’ process cluster includes processes for organization structure, security and risk management with International Organization for Standardization (ISO) 27001 and Control Objectives for Information and related Technology (COBIT) as primary industry framework reference, the ‘Application Management’ process cluster includes processes to manage applications with Capability Maturity Model Integration (CMMI) as the primary industry framework reference, and so forth. Further, as explained earlier, each of these process clusters include various processes. For example, the ‘Project Management’ process cluster includes processes such as ‘Project Initiation and Planning’, ‘Project Execution’, ‘Project Closure’, and the like.

Each of these processes in the process cluster should comply with a predefined set of standards. For example, ‘Threat Management’ should comply with International Organization for Standardization (ISO) 27001, ‘Governance’ should comply with Control Objectives for Information and related Technology (COBIT), ‘IT Service Management’ should comply with Information Technology Infrastructure Library version 3 (ITIL v3), and so forth. It may be apparent to a person skilled in the art that compliance of the process clusters with a predefined set of standards is required to authenticate or validate the processes being used by the organization. The compliance of a process with a standard verifies or checks whether the steps or activities involved in implementing the process are being followed.

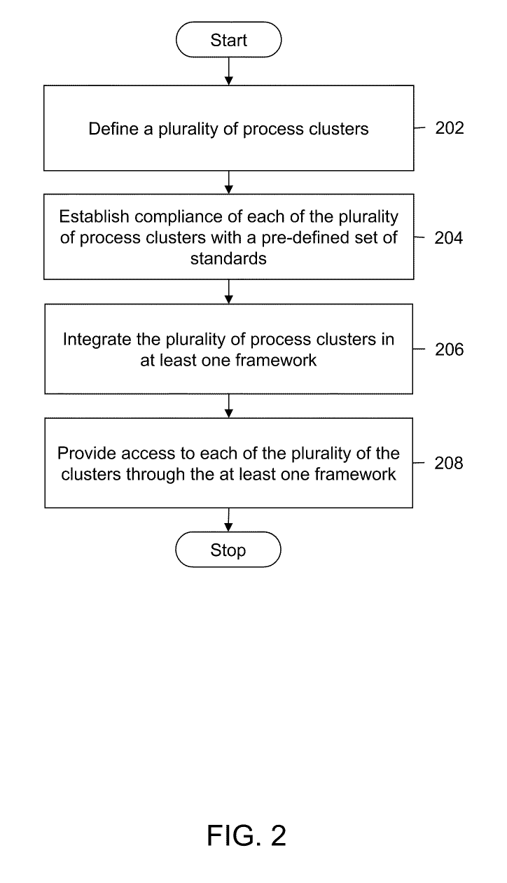

FIG. 2 is a flowchart of a method for managing processes in an organization, in accordance with an embodiment of the invention.

Typically, an organization employs various processes, also referred to as process capability areas, in various departments and at various stages. These processes are associated with various process clusters, as explained in detail in conjunction with FIG. 1.

At 202, a plurality of process clusters is defined. A process cluster relates to a predefined domain. In an embodiment of the invention, the process clusters relate to domains such as ‘Information Technology (IT) Service Management’, ‘Application Management’, ‘Governance and Security’, and ‘Project and Supplier Management’.

Each process cluster includes various processes. For example, ‘Application Management’ includes processes such as ‘Application Support’, ‘Application Enhancement’, ‘Application Testing’, and ‘Application Transition’. In an embodiment of the invention, the ‘IT Service Management’ process cluster includes 12 processes, namely, ‘Incident Management’, ‘Problem Management’, ‘Change Management’, ‘Release Management’, ‘Configuration Management’, ‘Service Level Management’, ‘Capacity Management’, ‘Availability Management’, ‘IT Service Continuity Management’, ‘Financial Management for IT’, ‘Technical Services Management’, and ‘Business Relationship Management’. Similarly, the ‘Governance and Security’ process cluster includes eight processes, namely, ‘IT Process and Organization Definition’, ‘Assess and Manage IT Risks’, ‘Manage IT Security’, ‘Measure and Report’, ‘Process Engineering’, ‘Quality Assurance’, ‘Knowledge Management for IT Operations’, and ‘Manage Training for IT’. Also, the ‘Project and Support Management’ process cluster includes five processes, namely, ‘Project Initiation and Planning’, ‘Project Execution’, ‘Project Monitoring and Control’, ‘Project Closure’, and ‘Supplier Management’. It may be apparent to any person skilled in the art there may be various other process clusters that can be defined by an organization, based on parameters such as the business model, needs and size of the organization, and so forth.

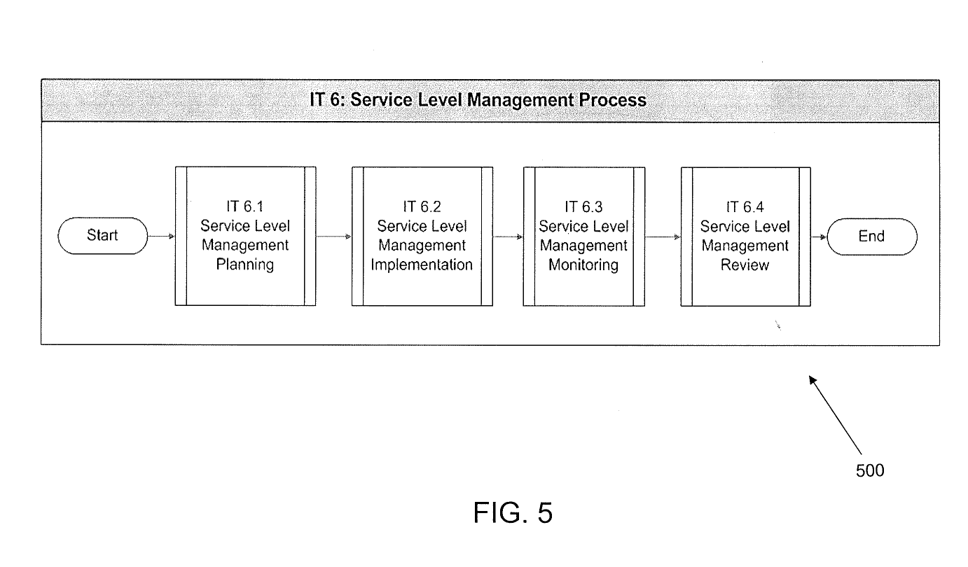

In various embodiments of the invention, process workflows are defined for each of the process clusters. The process workflows provide an overview of the working of the processes in the process cluster. The process workflows describe the activities involved in the corresponding processes on a broader level. In an embodiment of the invention, the process workflows are diagrammatically represented in the form of flowcharts also referred to as process flow diagrams. Each activity of a process is represented by a small block in the process flow diagram. These activities are also known as sub-processes of the process. An exemplary snapshot of a process workflow or a process flow diagram is depicted in FIG. 5.

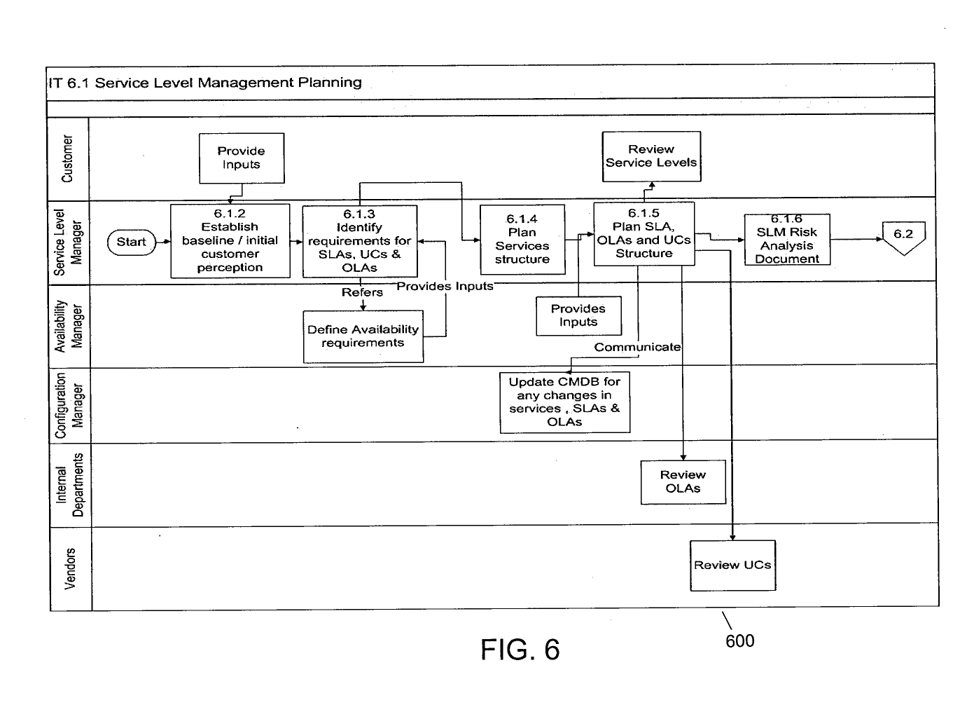

Similarly, sub-process swim lanes are defined for each of the processes. The sub-process swim lanes define the detailed working of the process and explain the activities involved in the process workflow. In other words, the sub-process swim lanes define the sub-processes of the process. Each block in the process flow diagram is explained in detail using the sub-process swim lanes. In an embodiment of the invention, the sub-process swim lanes are diagrammatically represented in the form of flowcharts also referred to as swim-lane diagrams. The swim-lane diagrams are role-based activity diagrams that explain the different roles of the resources, for example, people in the organization, in implementing each activity of the sub-process. An exemplary snapshot of a sub-process swim lane or a swim-lane diagram is depicted in FIG. 6.

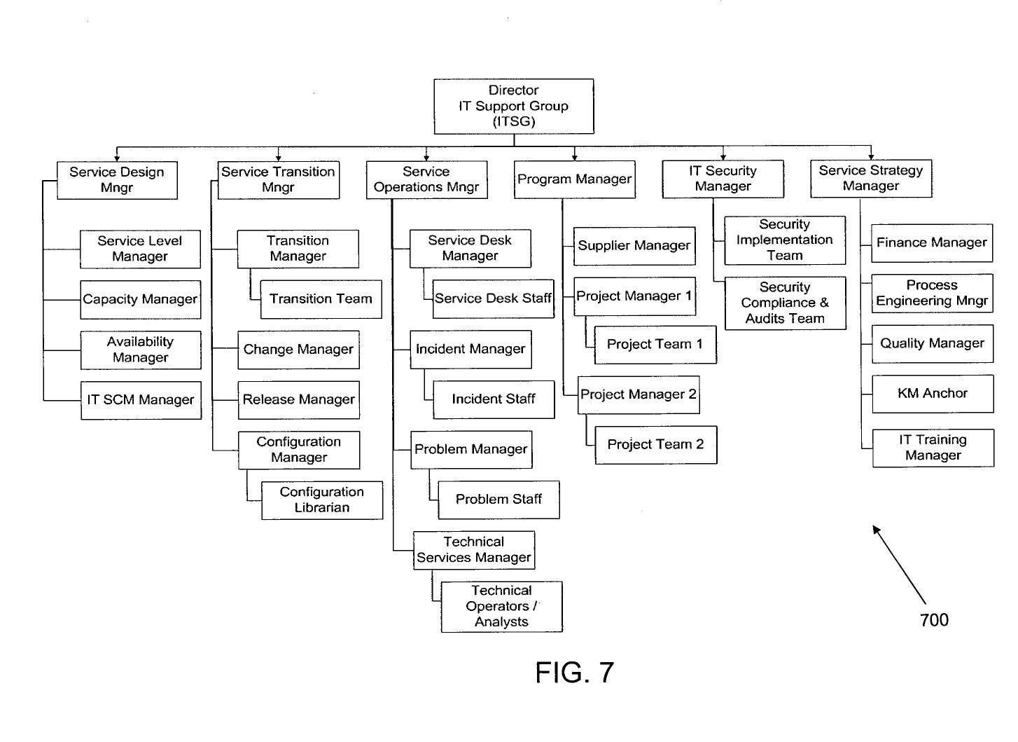

Various organization structures, also referred to as organization charts, are defined for the organization. The organization charts provide a logical view of the organization functions which can form a foundation for the organizational structure or organizational model. The organization charts explain how the various processes will be used in the organization and also the way the organization can be structured in terms of people, groups, resources, and the like. Further, the organization structure also provides the hierarchy of roles and responsibilities assigned to different people in the organization. An exemplary snapshot of an organization chart or an organization structure is depicted in FIG. 7.

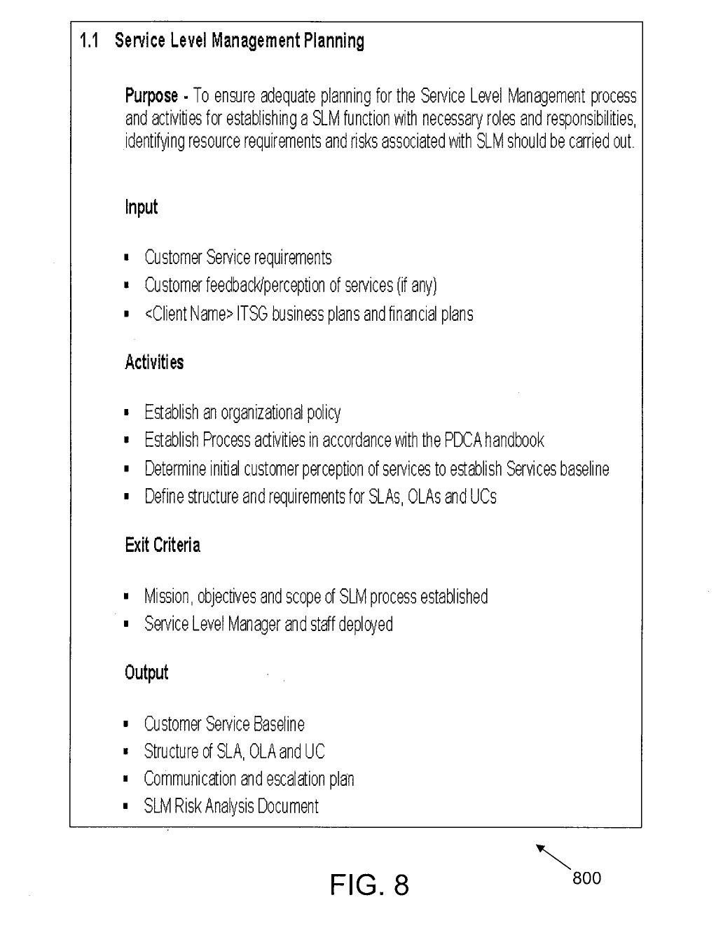

Various process components, such as process guidelines, process description and Responsible Accountable Consulted and Informed (RACI) charts, are defined for each of the process cluster. It will be evident to a person skilled in the art that the process components are defined for each of the processes associated with the process cluster. The process guidelines explain the guidelines associated with the processes. Similarly, the process description describes in detail the activities involved in the process. The process description provides a detailed understanding of the functions performed by the process and also provides details regarding the execution of the various steps or activities of the process and/or the sub-process. The process description includes details regarding the inputs required for the process, the outputs produced by the process, the exit criteria, the activities involved in the process, the business rules to be followed, and the like. Also, the process description and process guidelines include details regarding the process workflows, sub-process swim lanes and organization charts. They are used to explain the process flow diagrams, the swim-lane diagrams, and the like. An exemplary snapshot of a process description is depicted in conjunction with FIG. 8.

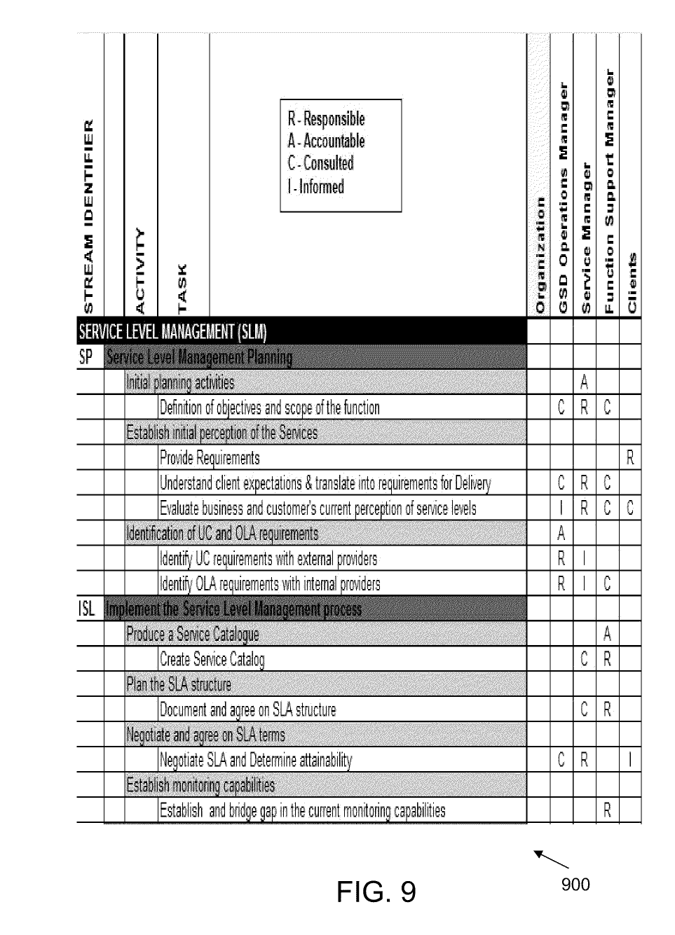

The RACI charts, also known as responsibility charts, provide details regarding the resources, for example, people, associated with a particular process. The RACI charts provide details of the persons responsible, accountable, consulted and informed in terms of their roles in the implementation of a particular process. In an embodiment of the invention, the RACI charts are diagrammatically represented in a tabular form. An exemplary snapshot of an RACI chart is depicted in conjunction with FIG. 9.

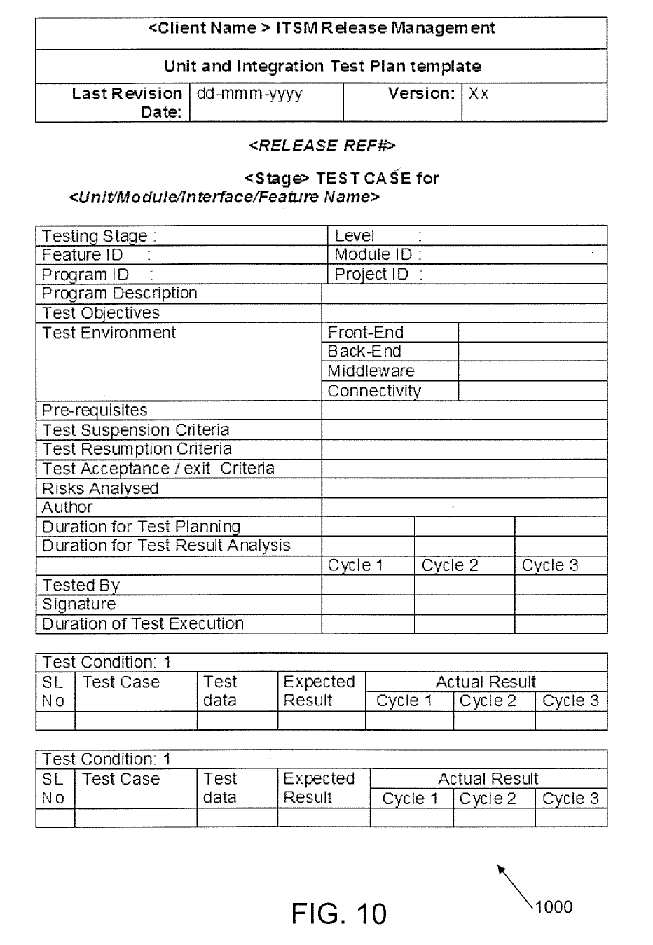

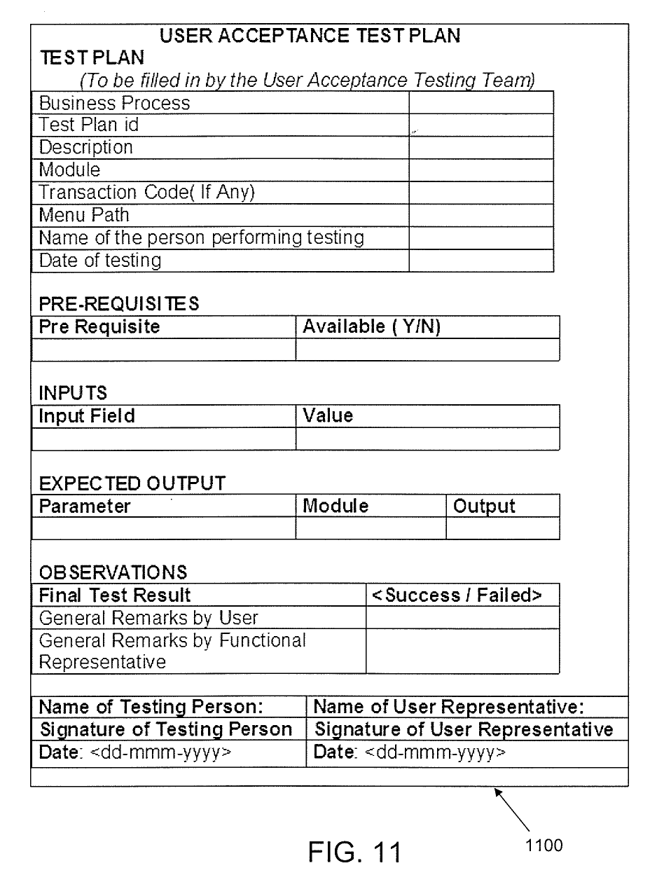

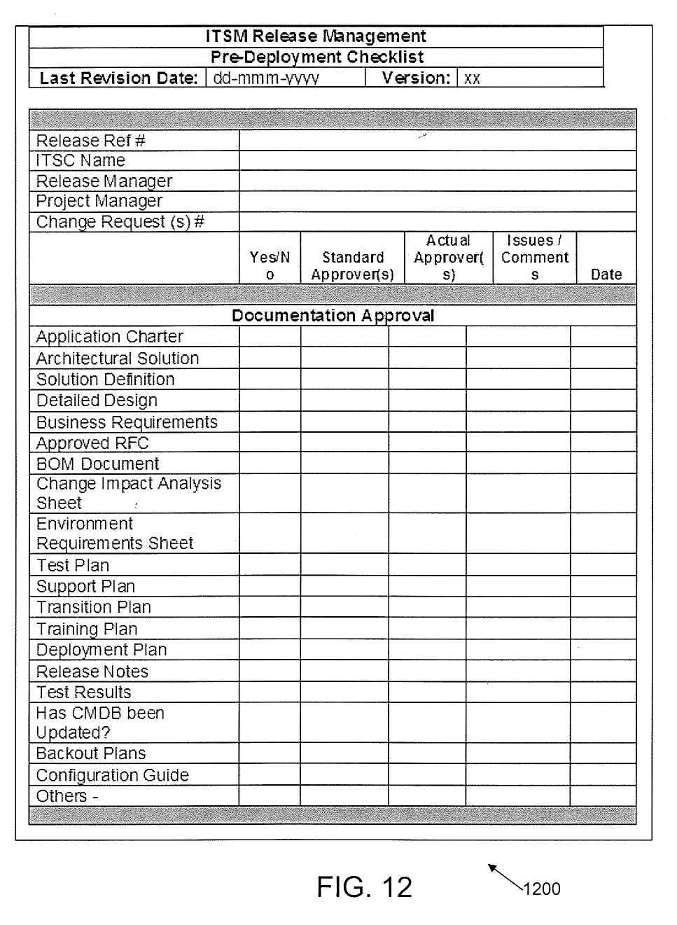

In various embodiments of the invention, the process components also include templates, forms and checklists corresponding to each process of the process cluster. The templates, forms and checklists are used as enablers to carry out different processes in the process cluster. The templates define a standardized format for various documents used for providing different services or functions to the users. The templates also provide a standardized format to enable consistency in the format of the information obtained from different users. An exemplary snapshot of a template is depicted in conjunction with FIG. 10. Similarly, the forms enable the users to provide the input details and obtain the output of the processes in a desired format. An exemplary snapshot of a form is depicted in conjunction with FIG. 11. A checklist is a list of rules to be followed during the implementation of a process. For example, a testing process is required to use a particular checklist to perform a particular test. In an embodiment of the invention, the templates, checklists and forms are collectively referred to as work products used for the process. An exemplary snapshot of a checklist is depicted in conjunction with FIG. 12.

In an embodiment of the invention, the processes, the process workflows, the sub-process swim lanes, the organization charts, and the process components such as process description, process guidelines, templates, forms and checklists are made available to a user in the form of a document repository of software such as Microsoft® Visios, Microsoft® Word, Microsoft® Excel, Microsoft® PowerPoint®, and the like. In another embodiment of the invention, the processes, process workflows, sub-process swim lanes, organization charts and process components are made available to a user as a web version that is developed by using HyperText Markup Language in Microsoft® FrontPage® as a tool.

At 204, a compliance of each of the process clusters is established with a predefined set of standards. The predefined set of standards includes standards such as ISO 27001, COBIT, and so forth. A partial and/or a full compliance of each process cluster with the predefined set of standards is established. It may be apparent to any person skilled in the art that the processes associated with each process cluster are made compliant with the predefined set of standards. In an embodiment of the invention, compliance of ‘IT Service Management’ is established with ITIL v3; compliance of ‘Application Management’ is established with Capability Maturity Model Integration version 1.2 (CMMI v 1.2); compliance of ‘Governance and Security’ is established with COBIT 4.1 and ISO 27001; and compliance of ‘Project and Supplier Management’ is established with Project Management Body Of Knowledge (PMBOK) and eSourcing Capability Model (eSCM).

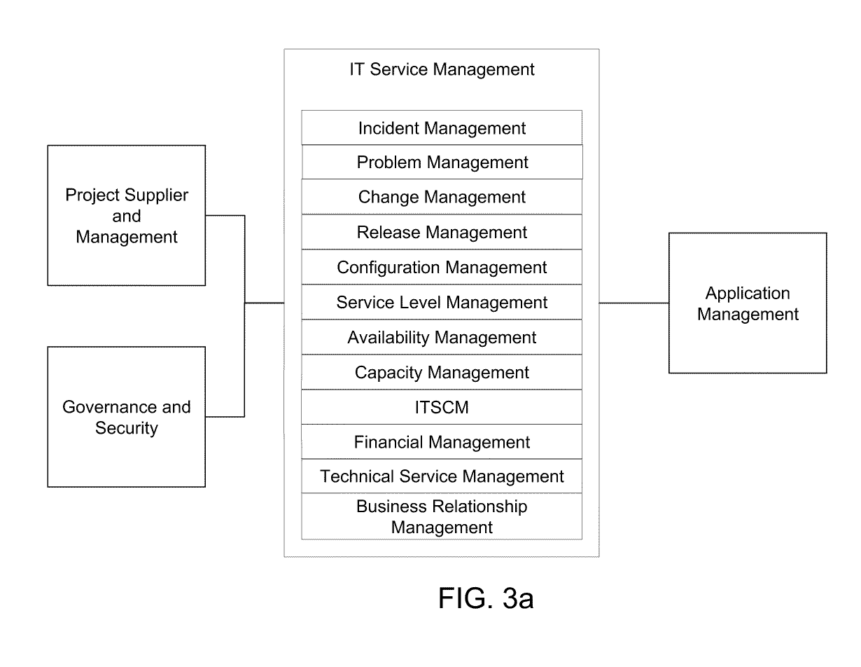

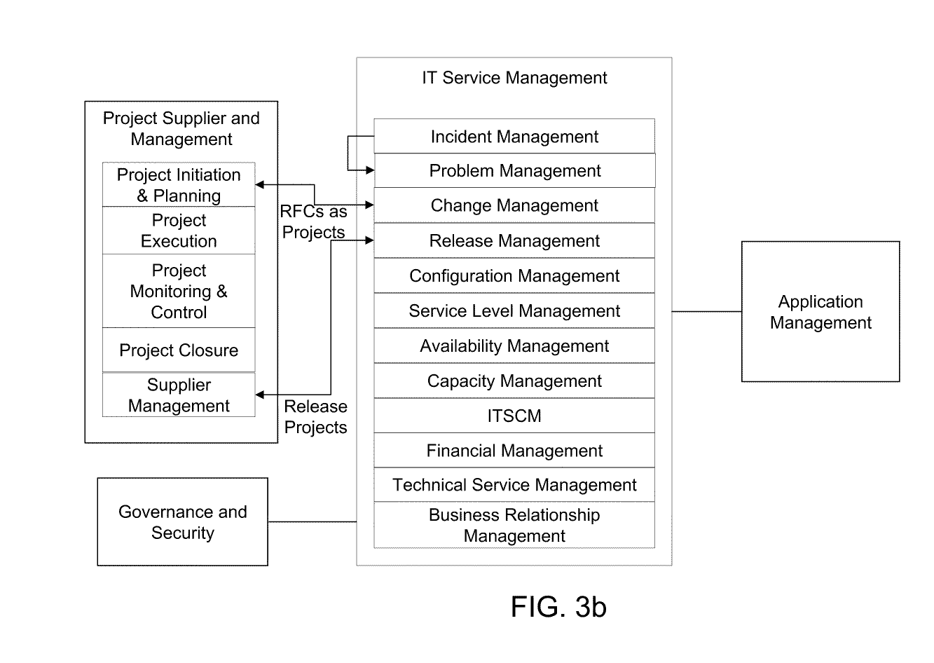

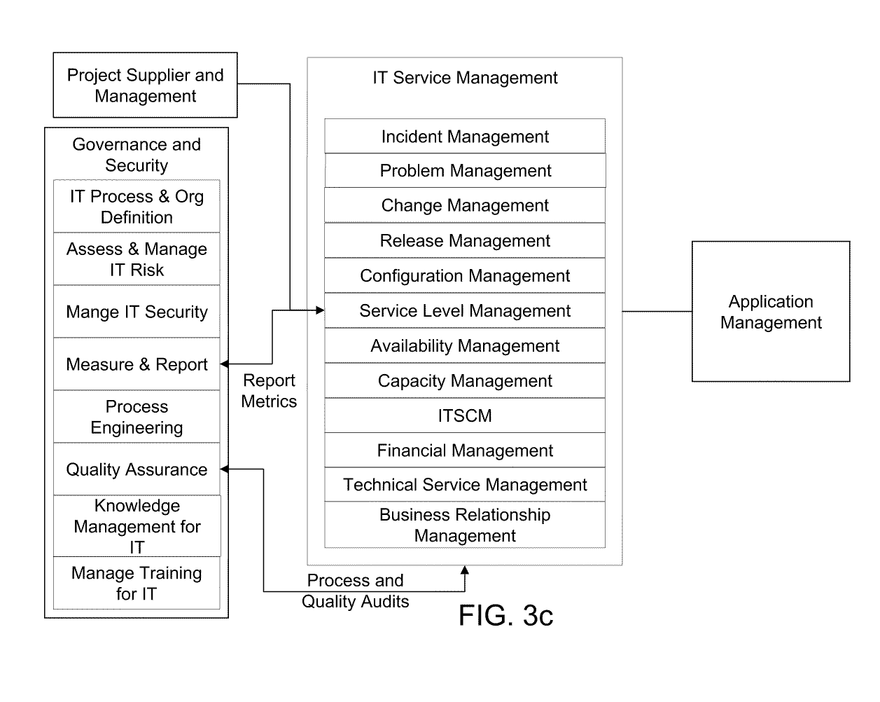

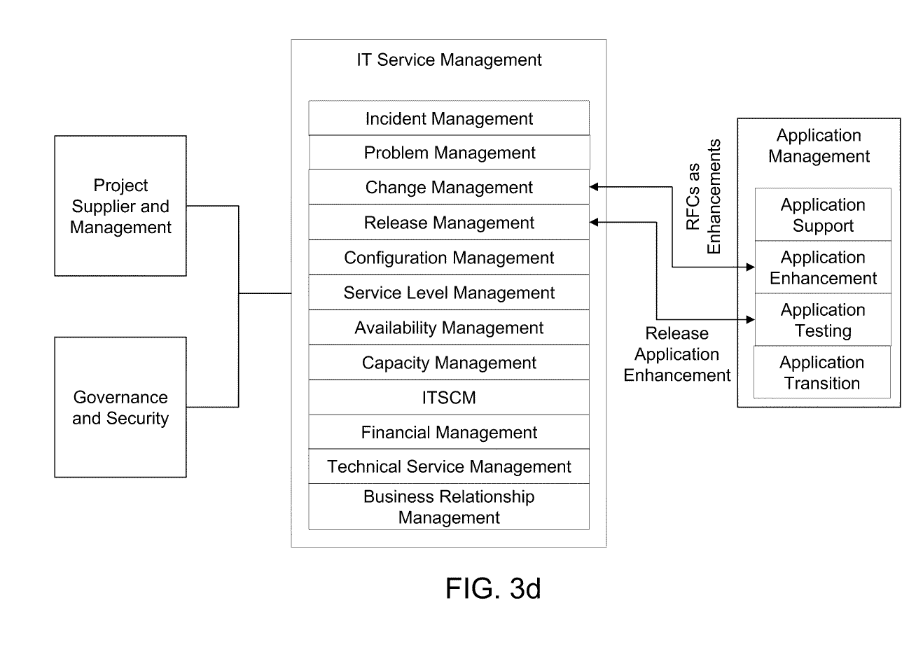

At 206, a plurality of process clusters is integrated in a framework. It may be apparent to any person skilled in the art that the plurality of process clusters can be integrated in more than one framework. Further, the integration of each process cluster, including the processes associated with the process cluster, is performed after taking into account its interdependency on the processes associated with the other process clusters. For example, the ‘IT Service Management’ process cluster is integrated with the ‘Project and Supplier Management’ process cluster, the ‘Application Management’ process cluster, and the ‘Governance and Security’ process cluster. Such integration facilitates interaction of a process cluster with the other process clusters. The interaction between the processes of various process clusters has been explained in detail in conjunction with FIG. 3. The integration of the process clusters in the framework enables concurrent implementation of the process clusters. In an embodiment of the invention, the process clusters can be individually implemented in the framework. In an embodiment of the invention, the interaction among the processes is monitored using the framework.

In an embodiment of the invention, the interdependency is decided by one or more experts in process consulting and industry best practice frameworks. The experts are people who have substantial experience in the industry and know about the various processes followed in an organization.

In another embodiment of the invention, the compliance can be established after the integration of the process clusters in the framework.

In addition to process clusters, the process workflows, sub-process swim lanes and organization charts corresponding to the different processes of the process clusters are also integrated in the framework. The various process components, such as process description, process guidelines, templates, checklists, and the like, are also integrated in the framework. It may be apparent to any person skilled in the art that the process workflows, sub-process swim lanes, organization charts and the process components can be integrated with the corresponding process clusters in more than one framework as well.

At 208, an access is provided to each of the process clusters using the framework. In various embodiments of the invention, the access is provided through a Graphical User Interface (GUI), which enables the users to access the process clusters. It may be apparent to a person skilled in the art that the users are able to access various processes, associated with the corresponding process clusters, through the GUI. For example, if the user accesses the ‘Application Management’ process cluster, he/she can also view all the associated processes. Further, the user can also view the associated process workflows, and the various process components such as process guidelines, process description, templates, checklists, and the like.

In an embodiment of the invention, the framework is customizable to be used in different organizations. In other words, the framework can be redesigned on the basis of the requirements of the organization. The customization of the framework is guided by factors such as changes in the processes, process workflows, sub-process swim lanes and the various process components such as process description, process guidelines, templates, forms, and the like. For example, in the customization of the framework, different activities of a process may be skipped or new activities may be added to a process on the basis of the needs of the organization. Also, various roles assigned in the different activities may be changed depending on the groups present in the organization. Further, the changes in the processes, process workflows and process components are implemented in the documented version of the processes. In other words, the processes are changed in Microsoft® Word, Microsoft® Excel and similar versions of the processes and the customized processes are implemented in the framework through the web version of the processes.

FIGS. 3a, 3b, 3c and 3d diagrammatically represent interactions of a process cluster with various other process clusters, in accordance with an exemplary embodiment of the invention.

In accordance with an exemplary embodiment, a process such as ‘Release Management’ associated with the ‘IT Service Management’ process cluster is made interdependent, that is, made capable of interacting, with the process ‘Application Enhancement’ associated with the ‘Application Management’ process cluster and the process ‘Supplier Management’ associated with the ‘Project and Supply Management’ process cluster. Similarly, interaction among various other processes is established based on their interdependency. Further, various interactions among the processes associated with the other process clusters with the process associated with the ‘IT Service Management’ process cluster have been diagrammatically shown in FIGS. 3a, 3b, 3c and 3d.

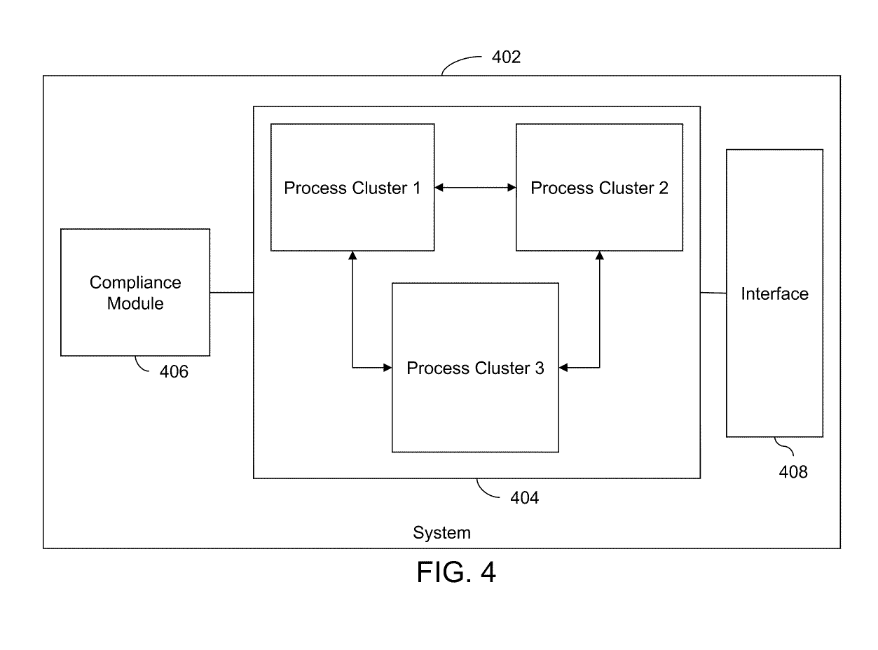

FIG. 4 is a block diagram of a system 402 for managing processes in an organization, in accordance with an embodiment of the invention. System 402 includes a framework 404, a compliance module 406, and an interface 408.

In various embodiments of the invention, system 402 enables a user to manage one or more processes in the organization. The processes are classified into process clusters, each of which is associated with a predefined domain. In an embodiment of the invention, the various process clusters relate to domains such as ‘Information Technology (IT) Service Management’, ‘Application Management’, ‘Governance and Security’, and ‘Project and Supplier Management’.

Framework 404 enables the user to define various process clusters such as process cluster 1, process cluster 2, and process cluster 3. For example, process cluster 1 can be ‘Application Management’, process cluster 2 can be ‘IT Service Management’, and process cluster 3 can be ‘Governance and Security’. The process clusters include associated processes. For example, the ‘Application Management’ process cluster includes processes such as ‘Application Support’, ‘Application Enhancement’, ‘Application Testing’, and ‘Application Transition’. Similarly, other process clusters include corresponding associated processes. Defining process clusters and associating processes with them has been explained in detail in conjunction with FIG. 2.

Framework 404 defines various process workflows, sub-process swim lanes, organization structures and process components, such as process guidelines, process description, templates, forms, and the like, for each of the processes associated with the corresponding process clusters. These parameters have been explained in detail in conjunction with FIG. 2. In an embodiment of the invention, the processes, process workflows, sub-process swim lanes, organization charts and process components are stored in the form of a document repository of software such as Microsoft® Visios, Microsoft® Word, and the like. In another embodiment of the invention, the processes, process workflows, sub-process swim lanes, organization charts and process components are stored as a web version developed by using HyperText Markup Language in Microsoft® FrontPage® as a tool.

Framework 404 integrates various process clusters on the basis of the interdependency among the processes. The integration of the process clusters enables concurrent implementation and interaction among various process clusters. For example, the ‘IT Service Management’ process cluster interacts with the ‘Project and Supplier Management’ and ‘Application Management’ process clusters. Such integration enables interaction among various processes of the process clusters. For example, a process such as ‘Release Management’ associated with the ‘IT Service Management’ process cluster interacts, in other words, is made interdependent with process ‘Application Enhancement’ associated with the ‘Application Management’ process cluster and process ‘Supplier Management’ associated with the ‘Project and Supply Management’ process cluster. Such interactions between the processes have been explained in detail in conjunction with FIG. 2 and FIGS. 3a, 3b, 3c and 3d. In an embodiment of the invention, the process clusters can be individually implemented in framework 404 in order to enable individual access.

Framework 404 also integrates the process workflows, sub-process swim lanes and organization charts corresponding to the different processes of the process clusters. The various process components such as process description, process guidelines, templates, checklists, and the like, are also integrated in framework 404.

Compliance module 406 establishes compliance of each process cluster with a predefined set of standards including standards such as ISO 27001, ITIL v2, PMBOK, eSCM, COBIT 4.1 and CMMI v1.2. For example, compliance module 406 establishes compliance of the ‘IT Service Management’ process cluster with ITIL v3. It may apparent to any person skilled in the art that establishing compliance of the process clusters includes establishing compliance of each of the associated processes with the predefined set of standards. Further, compliance module 406 includes a compliance control mapping sheet which assists in showing the compliance of the process clusters with a predefined set of standards. In an embodiment of the invention, framework 404 includes the compliance control sheet.

Interface 408 enables a user to access framework 404 and the integrated process clusters, and therefore, enables the user to access various processes associated with the corresponding process clusters. It may be apparent to any person skilled in the art that the user can access other interdependent processes of other process clusters through a process cluster currently accessed through interface 408. Further, interface 408 enables the user to access process workflows, sub-process swim lanes, organization charts, and process components such as process guidelines, templates, forms, and the like, for each of the processes associated with the corresponding process clusters. In an embodiment of the invention, interface 408 is a Graphical User Interface (GUI).

In an embodiment of the invention, framework 404 is customizable. In other words, framework 404 can be redesigned on the basis of the requirements of the organization. In various embodiments of the invention, framework 404, compliance module 406 and interface 408 can be implemented in the form of hardware, software, firmware, and/or combinations thereof.

FIG. 5 is a snapshot 500 depicting a process workflow in an organization, in accordance with an exemplary embodiment of the invention. Snapshot 500 depicts a process workflow associated with the ‘Service Level Management’ process in an exemplary embodiment of the invention. In other words, snapshot 500 illustrates a process flow diagram for the ‘Service Level Management’ process. The ‘Service Level Management’ process, as explained in conjunction with FIGS. 3a, 3b, 3c and 3d, is defined under the ‘IT Service Management’ process cluster. Further, snapshot 500 depicts the activities involved in carrying out the ‘Service Level Management’ process. As depicted, the ‘Service Level Management’ process involves activities such as ‘Service Level Management Planning’, ‘Service Level Management Implementation’, ‘Service Level Management Monitoring’, and ‘Service Level Management Review’. It may be apparent to any person skilled in the art that the activities will be performed by a user to carry out the process. Such activities are also called sub-processes, each of which includes one or more activities. Further, the activities to be performed to carry out a sub-process are explained in conjunction with FIG. 6.

FIG. 6 is a snapshot 600 depicting a sub-process swim lane for a particular activity or sub-process associated with a process, in accordance with an exemplary embodiment of the invention. Snapshot 600 depicts various activities associated with the ‘Service Level Management Planning’ sub-process. The ‘Service Level Management Planning’ sub-process is one of the activities or sub-processes associated with the ‘Service Level Management’ process, as illustrated in conjunction with FIG. 5. Various activities as depicted by snapshot 600 include ‘Establish baseline initial customer perception’, ‘Plan Services Structure’, and the like. Further, snapshot 600 depicts the different roles played by various people in carrying out the activities of the sub-process. For example, both the activities ‘Establish baseline initial customer perception’ and ‘Plan Services Structure’ are performed by a ‘Service Level Manager’. Similarly, different people have different roles such as ‘Customer”, ‘Availability Manager’, ‘Configuration Manager’, and so forth, for carrying out the various activities of the sub-process.

FIG. 7 is a snapshot 700 depicting the organization structure of an organization, in accordance with an exemplary embodiment of the invention. Snapshot 700 depicts an organization structure for the ‘IT Service Management’ process cluster. The organization structure depicts various roles involved in the organization for a particular process cluster. In other words, the organization structures depict the structure of an organization in terms of people, groups, resources, and the like. Further, the organization structure also provides the hierarchy of roles and responsibilities assigned to different people in the organization. For example, snapshot 700 depicts an organization structure of an IT Services Group corresponding to the ‘IT Service Management’ process cluster. The organization structure includes four levels of roles and responsibilities of different people. For example, Director is at the top level of hierarchy followed by Service Operations Manager at the second level with Transition Manager and Transition Team at the third and the fourth level, respectively.

FIG. 8 is a snapshot 800 depicting a process description associated with a process, in accordance with an exemplary embodiment of the invention. Snapshot 800 depicts the description of a sub-process ‘Service Level Management Planning’ associated with the ‘Service Level Management’ process of the ‘IT Service Management’ process cluster. As depicted in snapshot 800, a typical process description illustrates the purpose of the process and/or the sub-process. Further, the process description illustrates the inputs that are required from a user to perform the process and the activities that are involved in carrying out the process. Further, as depicted in snapshot 800, the process description also depicts the exit criteria and the output of the process. For example, the output as depicted by snapshot 800 is ‘Customer Service Baseline’, ‘Communication and Escalation Plan’, and the like.

FIG. 9 is a snapshot 900 depicting a Responsible Accountable Consulted and Informed (RACI) chart associated with the process, in accordance with an exemplary embodiment of the invention. Snapshot 900 depicts the roles assigned to different people corresponding to the different activities of the ‘Service Level Management’ process. The RACI charts provide details of the persons responsible, accountable, consulted and informed in terms of their roles in the implementation of the different activities of the process and/or sub-process. It will be evident to a person skilled in the art that a single person can play different roles in the execution of different activities. For example, ‘Service Manager’ is responsible for the activity ‘Definition of objectives and scope of the function’ and is consulted for the activity ‘Create Service Catalog’.

FIG. 10 is a snapshot 1000 depicting a template, in accordance with an exemplary embodiment of the invention. Following the example mentioned in FIG. 2, snapshot 1000 depicts a typical template for a testing process. For example, snapshot 1000 has various requirements that need to be filled by a user to conduct a testing process. Various examples of the requirements, as depicted in snapshot 1000, include ‘Testing Stage’, ‘Level’, ‘Project ID’, ‘Module ID’, and the like.

FIG. 11 is a snapshot 1100 depicting a form, in accordance with an exemplary embodiment of the invention. Following the example mentioned in FIG. 2, snapshot 1100 depicts a typical form for ‘User Acceptance Test Plan’. The form needs to be filled by the ‘User Acceptance Testing Team’ conducting a testing process. The form includes different fields such as ‘Pre-Requisites’, ‘Input’, ‘Output’, and the like.

FIG. 12 is a snapshot 1200 depicting a checklist for a process, in accordance with an exemplary embodiment of the invention. Snapshot 1200 depicts a checklist for ‘Release Management’ process associated with the ‘IT Service Management’ process cluster. Snapshot 1200 depicts various fields that need to be checked by a user before deploying or implementing an application. For example, the checklist for the ‘Release Management’ process includes a check for documentation approval.

The method, system and computer program product described above have a number of advantages. The method enables concurrent management of various processes using a single framework. Further, each process complies with the corresponding standard. Furthermore, the present invention enables an interaction among various processes, including those belonging to different process clusters. The method and system also enable the user to access these processes through a user-friendly interface, thereby facilitating accessibility throughout the organization and consistent understanding of the processes. The system also provides various process workflows and process descriptions, thus enabling common understanding of the processes. Moreover, the framework can be customized on the basis of the requirements of the organization, thus ensuring applicability across various organizations.

The system for managing one or more processes in an organization, as described in the present invention or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit and the Internet. The computer further comprises a microprocessor, which is connected to a communication bus. The computer also includes a memory, which may include Random Access Memory (RAM) and Read Only Memory (ROM). The computer system also comprises a storage device, which can be a hard disk drive or a removable storage drive such as a floppy disk drive, an optical disk drive, etc. The storage device can also be other similar means for loading computer programs or other instructions into the computer system. The computer system also includes a communication unit, which enables the computer to connect to other databases and the Internet through an Input/Output (I/O) interface. The communication unit also enables the transfer as well as reception of data from other databases. The communication unit may include a modem, an Ethernet card, or any similar device which enable the computer system to connect to databases and networks such as Local Area Network (LAN), Metropolitan Area Network (MAN), Wide Area Network (WAN) and the Internet. The computer system facilitates inputs from a user through an input device, accessible to the system through an I/O interface.

The computer system executes a set of instructions that are stored in one or more storage elements, in order to process the input data. The storage elements may also hold data or other information as desired. The storage element may be in the form of an information source or a physical memory element present in the processing machine.

The present invention may also be embodied in a computer program product for managing one or more processes in an organization. The computer program product includes a computer usable medium having a set program instructions comprising a program code for managing one or more processes in an organization. The set of instructions may include various commands that instruct the processing machine to perform specific tasks such as the steps that constitute the method of the present invention. The set of instructions may be in the form of a software program. Further, the software may be in the form of a collection of separate programs, a program module with a large program or a portion of a program module, as in the present invention. The software may also include modular programming in the form of object-oriented programming. The processing of input data by the processing machine may be in response to user commands, results of previous processing or a request made by another processing machine.

While the preferred embodiments of the invention have been illustrated and described, it will be clear that the invention is not limit to these embodiments only. Numerous modifications, changes, variations, substitutions and equivalents will be apparent to those skilled in the art without departing from the spirit and scope of the invention, as described in the claims.

What is claimed is:

1. A method for managing processes in an organization, the method comprising:
a. defining a plurality of process clusters, wherein each of the plurality of process clusters comprises one or more processes corresponding to a predefined domain in the organization;
b. establishing compliance of each of the plurality of process clusters with a predefined set of standards;
c. integrating the plurality of process clusters in at least one framework, wherein the integration enables a concurrent implementation of one or more process clusters; and
d. providing access to each of the plurality of process clusters through the at least one framework.

2. The method of claim 1, wherein the predefined domain is at least one of Information Technology service management, application management, project and supplier management, and governance and security.

3. The method of claim 1, wherein the predefined set of standards comprises at least one of Control Objectives for Information and related Technology (COBIT), Information Technology Infrastructure Library (ITIL), Project Management Body Of Knowledge (PMBOK), eSourcing Capability Model (eSCM), Capability Maturity Model Integration (CMMI) and International Organization for Standardization (ISO) 27001.

4. The method of claim 1 further comprising defining one or more process workflows corresponding to each of the plurality of process clusters.

5. The method of claim 4 further comprising integrating the one or more process workflows in the at least one framework.

6. The method of claim 1 further comprising defining one or more process components corresponding to each of the plurality of process clusters, wherein a process component comprises process description and process guidelines for the one or more processes in the corresponding process cluster.

7. The method of claim 6, wherein the process component further comprises at least one of one or more templates, one or more forms and one or more checklists.

8. The method of claim 1 further comprising monitoring interactions between the plurality of process clusters.

9. The method of claim 1, wherein the at least one framework is customizable.

10. The method of claim 1, wherein the integration of the plurality of process clusters enables individual implementation of each of the plurality of process clusters.

11. A system for managing processes in an organization, the system comprising:
a. at least one framework configured for defining and integrating a plurality of process clusters, each of the plurality of process clusters comprising one or more processes corresponding to a predefined domain in the organization, wherein the integration enables a concurrent implementation of one or more process clusters;
b. a compliance module configured for establishing compliance of each of the plurality of process clusters with a predefined set of standards; and
c. an interface for accessing the plurality of process clusters in the at least one framework.

12. The system of claim 11, wherein the framework is further configured for defining one or more process workflows corresponding to each of the plurality of process clusters.

13. The system of claim 12, wherein the framework is further configured for integrating the one or more process workflows in the at least one framework.

14. The system of claim 11, wherein the framework is further configured for defining one or more process components corresponding to each of the plurality of process clusters, wherein a process component comprises process description and process guidelines for the one or more processes in the corresponding process cluster.

15. The system of claim 14, wherein the process component further comprises at least one of one or more templates, one or more forms and one or more checklists.

16. The system of claim 11, wherein the predefined domain is at least one of Information Technology service management, application management, project and supplier management, and governance and security.

17. The system of claim 11, wherein the predefined set of standards comprises at least one of Control Objectives for Information and related Technology (COBIT), Information Technology Infrastructure Library (ITIL), Project Management Body Of Knowledge (PMBOK), eSourcing Capability Model (eSCM), Capability Maturity Model Integration (CMMI) and International Organization for Standardization (ISO) 27001.

18. The system of claim 11, wherein the framework is further configured for monitoring interactions between the plurality of process clusters.

19. The system of claim 11, wherein the at least one framework is customizable.

20. The system of claim 11, wherein the at least framework enables individual implementation of each of the plurality of process clusters.

21. A computer program product for use with a computer, the computer program product comprising a computer usable medium having a computer readable program code embodied therein for managing processes in an organization, the computer readable program code performing:
a. defining a plurality of process clusters, wherein each of the plurality of process clusters comprises one or more processes corresponding to a predefined domain in the organization;
b. establishing compliance of each of the plurality of process clusters with a predefined set of standards;
c. integrating the plurality of process clusters in at least one framework, wherein the integration enables a concurrent implementation of one or more process clusters; and
d. providing access to each of the plurality of process clusters through the at least one framework.

22. The computer program product of claim 21, wherein the computer readable program code further performs defining one or more process workflows corresponding to each of the plurality of process clusters.

23. The computer program product of claim 22, wherein the computer readable program code further performs integrating the one or more process workflows in the at least one framework.

24. The computer program product of claim 21, wherein the computer readable program code further performs defining one or more process components corresponding to each of the plurality of process clusters, wherein a process component comprises process description and process guidelines for the one or more processes in the corresponding process cluster.

25. The computer program product of claim 21, wherein the computer readable program code further performs monitoring interactions between the plurality of process clusters.
